(19) United States
(12) Patent Application Publication
(10) Pub. No.: US 2008/0131039 A1
(43) Pub. Date: Jun. 5, 2008

(54) Tilting pad thrust bearing

(75) Inventor: Nigel Henry New, Middlesex (GB)

Correspondence Address: RYAN KROMHOLZ & MANION, S.C., POST OFFICE BOX 26618, MILWAUKEE, WI, 53226, US

(73) Assignee: Delaware Capital Formation, Inc.

(21) Appl. No.: 11/998,279

(22) Filed: Nov. 29, 2007

(30) Foreign Application Priority Data
Dec. 1, 2006 (GB) GB 062389.1

(51) Int. Cl. F16C 32/06

(52) U.S. Cl. 384/122

(57) ABSTRACT

A pad thrust bearing assembly is described, including a substantially solid flat carrier body being of generally annular configuration having a central circular aperture and outer circular periphery, a plurality of bearing pads arranged thereon between the perimeter of said central aperture and said outer circular periphery, locating means for maintaining both the separation and position of the bearing pads on the carrier body, and fulcrum means which permits said bearing pads to pivot about a substantially radial axis while in their predetermined position. The assembly is designed such that the locating means for maintaining the separation and position of said bearing pads is a locating component which includes at least one of a hub portion and a rim portion from which a plurality of ribs project, which together define a plurality of regions of a size and shape which permits the bearing pads to be received therein.

### RELATED APPLICATION

This application claims the benefit of co-pending United Kingdom Patent Application No. GB 0623989.1, filed 1 Dec. 2006.

### FIELD OF THE INVENTION

This invention relates to a tilting pad thrust bearing for apparatus having a rotating shaft which carries a thrust load.

### BACKGROUND OF THE INVENTION

Tilting pad thrust bearing arrangements are well known per se, having discrete bearing pads and against which the pads bear to transmit axial thrust forces.

The supporting carrier means for the bearing pads is formed either as a metal ring of such thickness as to support the thrust loads without deformation or sometimes as a prepared surface of the apparatus housing the bearing arrangement. In either case it is conventional for the pad-supporting face of the carrier means to be substantially flat in the axial direction, except possibly for lubricant nozzles at the surface, and for the face of each thrust pad opposite to a bearing surface to be machined away except at a central or circumferentially off set location to leave a radially-extending fulcrum ridge by way of which the pad is supported on said supporting face of the carrier means and about which fulcrum ridge it is able to make limited tilting movement.

It will be appreciated that in the case of individual pads or an integral ring of such pads, the provision of such fulcrum ridge on the supported pad surfaces involves an additional and non-trivial manufacturing stage.

GB-A-1535165 describes a thrust bearing arrangement wherein parallel surfaced bearing pads are supported on a smooth faced carrier by way of an intervening plate machined such that it presents an upstanding fulcrum ridge to each bearing pad. Whereas this construction permits the bearing pads to be of simpler and cheaper construction, the machined plate nevertheless requires considerable manufacturing effort.

In use, such thrust bearings are typically provided with a supply of lubricant which not only provides a friction reducing effect between the thrust bearing pad friction surfaces and the collar of a shaft against which they act and also provides a cooling effect on the bearing.

In this regard, FIG. 1 shows a partially sectioned view of a shaft-end housing in which thrust bearings of the type with which this invention is concerned are shown. In particular, a shaft 2 having an end 4 provided with a collar 6 clamped to the end of the shaft by means of a nut or boss 8 is disposed in a housing indicated generally at 10. The housing is provided with a thrust bearing cavity 12 which receives the collar 6 and in which are disposed a pair of oppositely orientated circular thrust bearings 14, each having a plurality of circumferentially arranged bearing pads 16 which are arranged to tilt about a radial axis as previously described. Such a thrust bearing is shown in FIG. 2, and from FIGS. 1 and 2, it can be seen that the conventional arrangement is to mount an intermediate ring component 17B to a carrier body 17A, and then to secure the bearing pads 16 to in pivoting manner to said intermediate ring component 17B by means of threaded fixing members 17C (not shown in FIG. 2).

In use, the shaft 2 rotates as indicated at 18, and oil is pumped into the housing through inlet 20 and caused to circulate in the bearing cavity 12 around each of the thrust bearings before passing through an oil outlet 22 to a drain or sump 24. The arrows 26 shown within the bearing cavity 12 demonstrate the manner in which the oil flows, and in particular the oil is caused to flow around the rear surfaces of the thrust bearings by means of oil flow recesses and channels provided in the bearing pad carrier body, as can be seen in FIGS. 3 and 4.

In these figures, a typical carrier body 30 is shown having a plurality of circumferentially arranged recesses 32 provided in the peripheral surface thereof which feed oil circulation channels 34 provided in the rear surface of said carrier body. The bearing pads are mounted to the carrier body within a rebated inner portion 36 such that in use, the oil flows from the inner central aperture of the carrier body towards its out periphery, over and around the bearing pads, and thence behind the carrier body by flowing down the passageways formed, firstly between the recesses 32 and in the inner surface of the housing in which the thrust bearings are disposed (oil thus flowing in an axial direction through such passageways), and secondly between the channels 34 and the front or rear walls of said housing (oil flowing radially through such passageways), before being again caused to flow over and around the bearing pads.

While such oil flows have in the past been thought to be satisfactory, the safety of the bearing is dependent to a certain degree on their operating temperature of the pads, and any additional cooling which can be achieved, through improved oil circulation or other design consideration, is desirable as the bearing will run with a greater safety margin.

It is an object of this invention to provide a thrust bearing which allows for improved oil circulation around the bearing pads thereof, and which thus provides a bearing with a longer life.

### SUMMARY OF THE INVENTION

According to the invention there is provided a pad thrust bearing assembly comprising a substantially solid flat carrier body being of generally annular configuration having a central circular aperture and outer circular periphery, a plurality of bearing pads arranged thereon between the perimeter of said central aperture and said outer circular periphery, and locating means for maintaining both the separation and position of the bearing pads on the carrier body, and fulcrum means which permits said bearing pads to pivot about a substantially radial axis while in their predetermined position, characterized in that the locating means for maintaining the separation and position of said bearing pads is a locating component which includes at least one of a hub portion and a rim portion from which a plurality of ribs project, which together define a plurality of regions of a size and shape which permits the bearing pads to be received therein, and further characterized in that the locating component is maintained in spaced apart relationship with the carrier body, and has outermost and innermost radial dimensions which satisfy at least one of the following conditions:
the outermost radial dimension is less than the outer peripheral radial dimension of the carrier body
the innermost radial dimension is greater than the aperture perimetral radial dimension of the carrier body
both the above
   such that lubricant is permitted to flow radially outwardly over the locating component on one side thereof and radially inwardly on the other side thereof or vice versa, one of said flows being between said locating component and the carrier body adjacent thereto.

Most preferably, the locating component includes both an hub portion and a rim portion joined by ribs which together define apertures in which the bearing pads are received.

In one embodiment, the fulcrum means are provided by an intermediate component disposed between the carrier body and the locating component, said component having a hub portion and a rim portion joined by ribs on which the bearing pads are disposed and about which they can pivot.

Alternatively the fulcrum may be on either the pad or the carrier body.

In one embodiment, the hub and rim portions of either or both of the locating component and intermediate component are discontinuous.

Preferably at least one of said locating component and said bearing pads has means which project so as to be capable of engaging the other, by which engagement the axial displacement of the bearing pads away from the carrier body is controlled.

Preferably, the locating component and the bearing pads cooperate by means of the bearing pads having, one or more peripheral lips around their base to increase the peripheral dimensions thereof to an extent that said lip(s) cannot pass through the apertures defined in the locating component, but the bearing pad body is not prevented from doing so.

Most preferably, the locating ring, and further preferably the intermediate component are both cut from sheet steel, preferably by laser means. Alternatively, such components may be stamped, punched or cut by water jet.

Preferably each of the carrier body, the intermediate component and the locating component of the assembly is provided with secondary apertures through which fixings pass in the assembly to angularly orientate the components correctly with respect to one another.

In a most preferred arrangement, spacer elements are provided, integrally with said fixings or separately therefrom, to maintain the spaced apart relationship of the locating component and carrier body.

In a most preferred embodiment, the fixings used are of the type which preclude the need for the secondary apertures to be tapped, examples being clinch nuts or hank bushes, which are interferingly or weldably secured to the locating component, and allow for threaded fixing members to pass through the secondary apertures in the carrier body and intermediate component and be received in the tapped bore of the nut or bush during assembly.

In a most preferred embodiment, the rear surface of the carrier body, being on the opposite side of that on which the other components of the assembly are provided, is counter-sunk or counter-bored in the region of said secondary apertures to allow the bolt heads to be flush with or beneath the rear surface of said carrier body.

In a further preferred embodiment, one or other or both of the locating component and the intermediate component are split into two or more parts.

The primary advantage of the above described arrangement is that when the thrust bearing assembly is in-situ within apparatus and disposed around a rotating shaft of said apparatus, there is no need to provide the carrier body with the peripheral recesses or notches, and rear-surface lubricant flow grooves. Accordingly the carrier body of the assembly can be made with significantly less expense.

A further advantage is that permitting the lubricant flow between carrier body and locating component enhances the cooling effect provided by the lubricant to the bearing pads.

A specific embodiment of the invention is now provided by way of example with reference to the accompanying diagrams, wherein

### BRIEF DESCRIPTION OF THE DRAWINGS

FIG. 1 provides a sectional view of a double thrust bearing in-situ in rotary apparatus having a rotationally driven shaft,

FIG. 2 is a perspective view of a prior art thrust bearing,

FIGS. 3 and 4 provide perspective views of the front and rear surfaces of the carrier body of the thrust bearing of FIG. 2

FIG. 5 provides a exploded perspective view of one embodiment of a thrust bearing according to the present invention, and

FIG. 6 provides a sectional view of the thrust bearing of FIG. 5 in situ in apparatus having a rotationally driven shaft.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

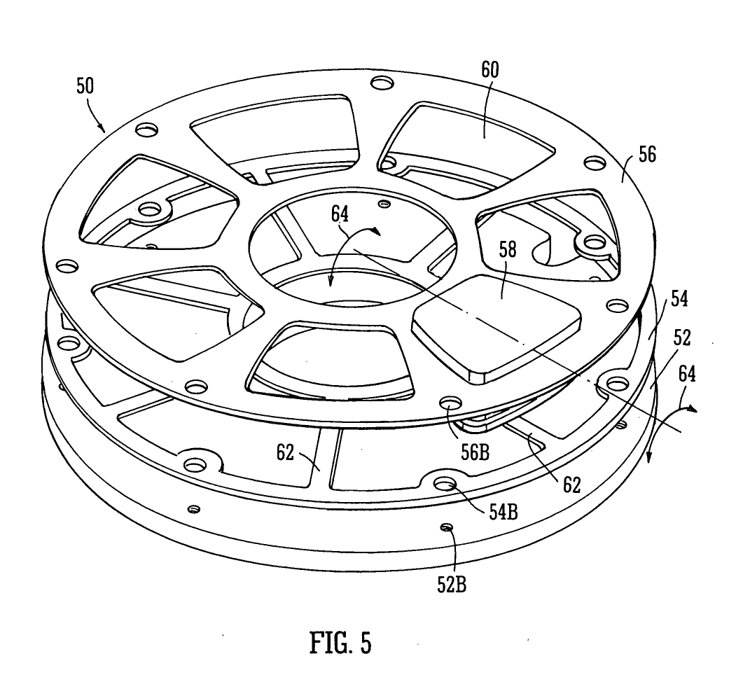

Referring first to FIG. 5, there is shown a thrust bearing indicated at 50 which includes a generally circular, laser machined and generally solid carrier body 52, an intermediate component 54, and a locating component 56. Bearing pads, one of which is shown at 58, are arranged in the apertures 60 defined in the locating component 56 which is disposed on top of the intermediate component 54 such that the ribs 62 thereof are disposed beneath each of the bearing pads to act as fulcrums therefore. All of the locating component 56, the intermediate component 54, and the carrier body 52 are provided with secondary fixing apertures 56B, 54B, 52B which are aligned to receive suitable fixing members, in the form of screws or bolts which pass through from the rear surface of the carrier body 52 and into hank bushes or clinch nuts, being commonly available items, which are secured to the upper surface of the locating component 56. The rocking or pivoting motion of the bearing pads 58 is shown by arrows 64.

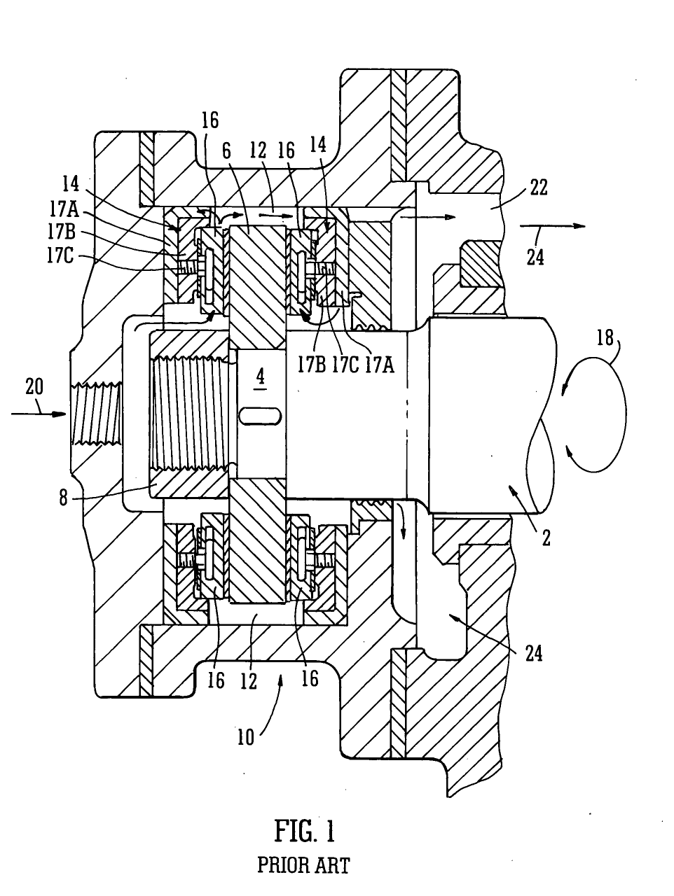

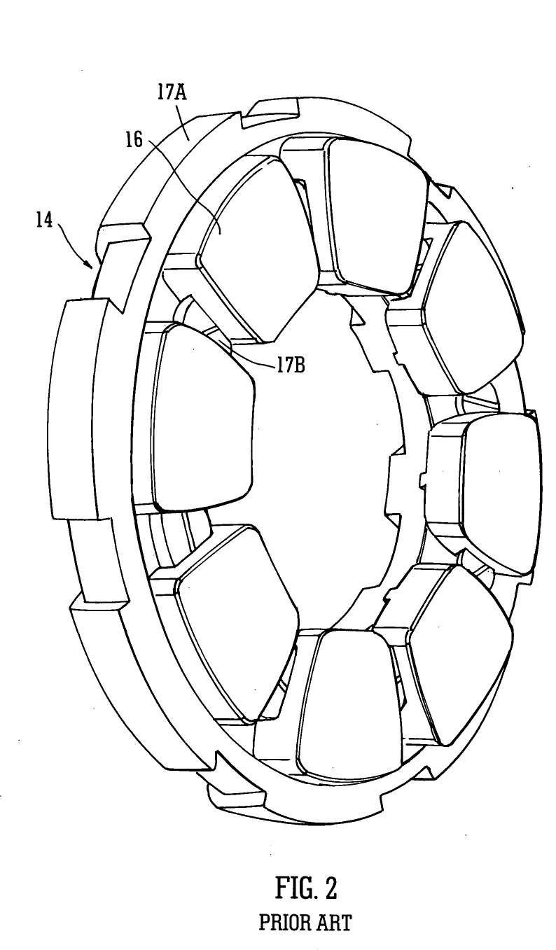

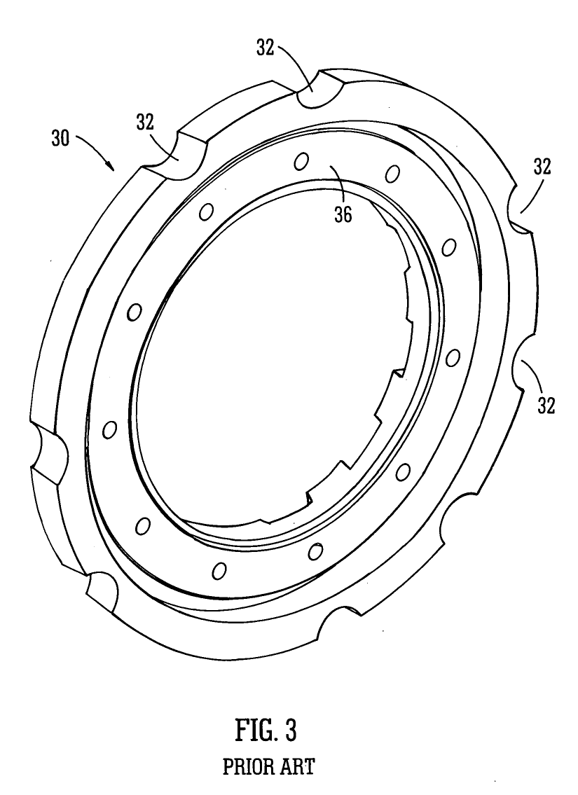

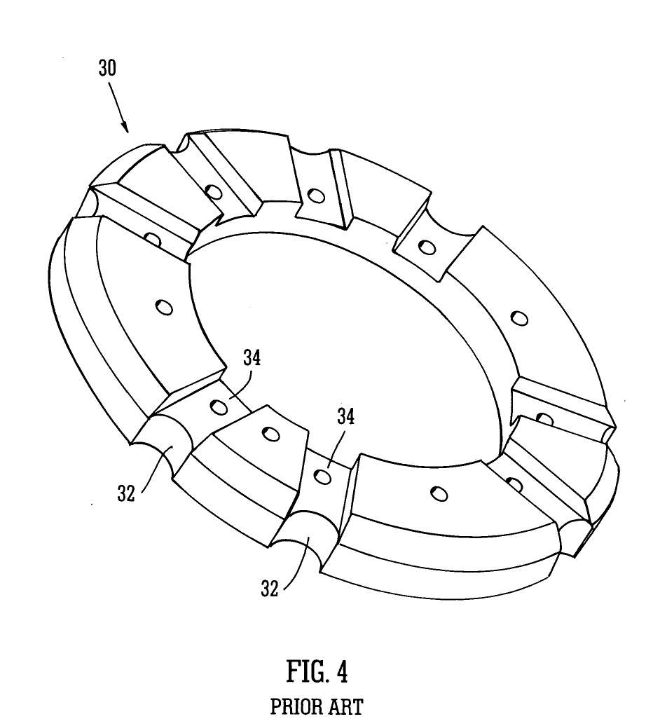

Although in this embodiment, the intermediate component is shown as being of planar, unitary construction as more fully described in applicant's co-pending application of even date, it is to be mentioned that a more conventional intermediate component my be used, as shown in FIG. 1.

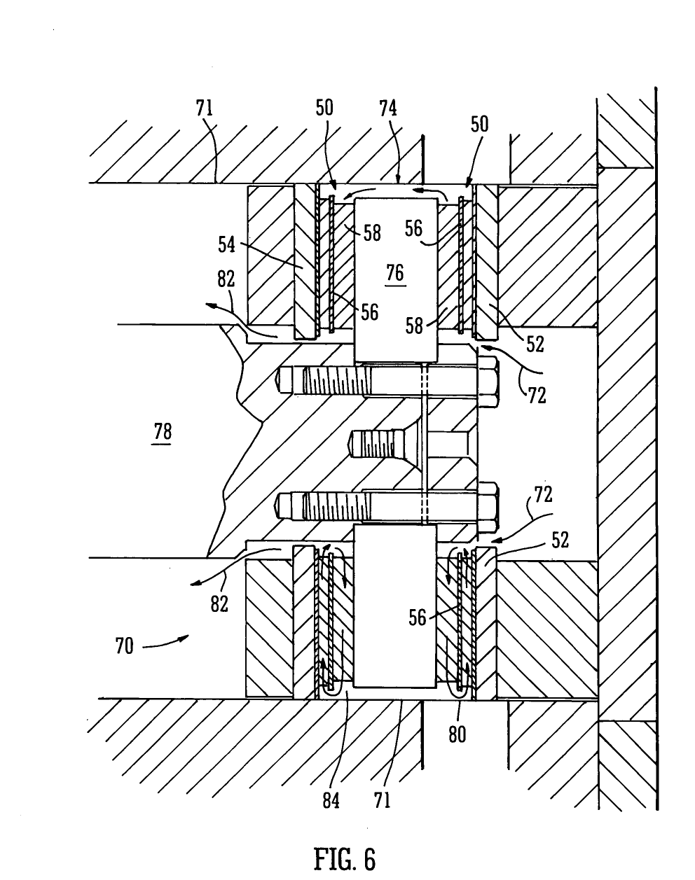

The primary distinction between this invention and the prior art configurations is the relative radial dimensions of the outer periphery of the locating component (which have heretofore not formed part of thrust bearing assemblies), and the corresponding carrier body, and also, the relative radial dimensions of the innermost perimeter of the locating component as compared to the radial perimetral dimensions of the central aperture through the carrier body, in conjunction with the accessible space between the carrier body 52 and the location plate 56, as can be seen in FIGS. 5 and 6.

In this regard, and referring to FIG. 6 wherein a pair of thrust bearings 50 is shown in situ in apparatus 70 having a housing 71. In use, the oil flow enters the apparatus as shown at arrow 72, and enters the cavity 74 defined in the apparatus in which the thrust bearings 50 provide axial support for a collar 76 secured to a shaft 78 of the apparatus. The bearing pads 58 are shown in co-operation with opposite radial surfaces of the collar, and a locating component 56, is shown having radial outermost and innermost dimensions less than the outermost radial dimension, and greater than innermost dimension of the central aperture, respectively, of the carrier body. This permits a circulatory lubricant flow as indicated at 80. The oil flow between the locating component 56 and the carrier body 52 is to be noted. After the oil has been circulated within said cavity 74, it exits through the outlet 82.

In particular, it is to be noted that the outermost radial dimension of the locating component 56 defines an annular gap 84 through which the oil is allowed to flow to circulate around the sides of bearing pads 58 and between the locating component and the carrier body 52. In this regard, the diameter of the housing 71 is important in that the inner surface of the housing 71, together with the outer periphery of the locating component, defines the annular gap through which oil can flow. It will be appreciate that in circumstances where the housing diameter is sufficient to accommodate bearing assemblies in such a manner that gaps are defined to the outside of both the carrier body and the locating component of said assemblies, there is no need for the locating component to be radially inset from the outer periphery of the carrier body, as a gap will be defined between the peripheries of both locating component and carrier body, and the innermost surface of the cylindrical housing in which they are disposed.

It should also be noted that invention is also applicable to bearings where heat is extracted directly through the bearing housing where the bearing operates in an oil bath without a feed into or out of the bearing housing.

I claim:

1. A pad thrust bearing assembly comprising:
a substantially solid flat carrier body being of generally annular configuration having a central circular aperture and outer circular periphery;
a plurality of bearing pads arranged thereon between the perimeter of said central aperture and said outer circular periphery; and
locating means for maintaining both the separation and position of the bearing pads on the carrier body, and fulcrum means which permits said bearing pads to pivot about a substantially radial axis while in their predetermined position, characterized in that the locating means for maintaining the separation and position of said bearing pads is a locating component which includes at least one of a hub portion and a rim portion from which a plurality of ribs project, which together define a plurality of regions of a size and shape which permits the bearing pads to be received therein, and further characterized in that the locating component is maintained in spaced apart relationship with the carrier body to allow for radially inward or outward oil flow therebetween.

2. An assembly according to claim 1 wherein the locating component includes both an hub portion and a rim portion joined by ribs which together define apertures in which the bearing pads are received.

3. An assembly according to claim 1 wherein the fulcrum means are provided by an intermediate component disposed between the carrier body and the locating component, said component having a hub portion and a rim portion joined by ribs on which the bearing pads are disposed and about which they can pivot.

4. An assembly according to claim 1 wherein the fulcrum means is provided on the bearing pad.

5. An assembly according to claim 1 wherein the fulcrum means is provided on the carrier body.

6. An assembly according to claim 1 wherein at least one of the hub and rim portions of the locating component is discontinuous.

7. An assembly according to claim 3 wherein at least one of the hub and rim portions of the intermediate component is discontinuous.

8. An assembly according to claim 1 wherein at least one of said locating component and said bearing pads has means which project so as to be capable of engaging the other, by which engagement the axial displacement of the bearing pads away from the carrier body is controlled.

9. An assembly according to claim 8 wherein the locating component and the bearing pads cooperate by means of the bearing pads having one or more peripheral lips around their base to increase the peripheral dimensions thereof to an extent that said lip(s) cannot pass through the apertures defined in the locating component, but the bearing pad body is not prevented from doing so.

10. An assembly according to claim 1 wherein at least one of the locating ring, the intermediate component, and the carrier body are both cut from sheet steel by laser means.

11. An assembly according to claim 1 wherein at least one of the locating ring, the intermediate component, and the carrier body is stamped, punched or cut by water jet.

12. An assembly according to claim 1 wherein the intermediate component and the locating component of the assembly are provided with secondary apertures through which bolts pass in the assembly to angularly orientate the components correctly with respect to one another.

13. An assembly according to claim 12 wherein fixing members are provided to receive the bolts and thus secure the assembly.

14. An assembly according to claim 13 wherein the fixing members are selected from the group of clinch nuts or hank bushes.

15. An assembly according to claim 12 wherein spacer elements are provided to maintain the spaced apart relationship of the locating component and carrier body, said spacer elements receiving at least a portion of the bolts.

16. An assembly according to claim 15 wherein the fixing members are selected from the group of clinch nuts or hank bushes and wherein the spacer elements form an integral part of the fixing members.

17. An assembly according to claim 12 wherein the fixing members are interferingly or weldably secured to the locating component.

18. An assembly according to claim 12 wherein the fixing members are provided with a tapped bore, and the bolts are threaded so as to be capable of being screwed into said tapped bore of said fixing members to secure the assembly.

19. An assembly according to claim 12 wherein the rear surface of the carrier body is counter-sunk in the region of the secondary apertures.

20. An assembly according to claim 1 wherein at least one of the locating component and the intermediate component is split into two or more parts.

21. An assembly according to claim 1 wherein the locating component has outermost and innermost radial dimensions which satisfy both of the following conditions:
the outermost radial dimension is less than the outer peripheral radial dimension of the bearing housing in the area between the carrier body and the thrust collar;
the innermost radial dimension is greater than the aperture perimetral radial dimension between the shaft and carrier body in the area between the carrier body and the thrust collar such that lubricant is permitted to flow radially outwardly over the locating component on the side adjacent to the collar and radially inwardly on the other side thereof or vice versa, one of said flows being between said locating component and the carrier body adjacent thereto.

22. An assembly according to claim 1 which, when disposed in a housing arranged around a rotatable shaft, defines a pair of annular gaps, a first annular gap being defined between the outer periphery of the locating component and said housing, and a second being defined between the inner perimeter of the locating component and said shaft thus enabling oil flow through said annular gaps and between said locating component and the carrier body.

23. An assembly according to claim 22 wherein at least one of the annular gaps is of greater radial dimension than the corresponding gaps, if such are present, between the outer periphery of the carrier body and the housing and inner perimeter of the carrier body and the shaft.

24. An assembly according to claim 22 wherein the carrier body is snugly fitted within the housing such that no annular gap exists between the outer periphery of said carrier body and the housing.
